(19) United States
(12) Patent Application Publication
(10) Pub. No.: US 2004/0206214 A1
(43) Pub. Date: Oct. 21, 2004

(54) Adjustable wrench having ratchet and locking features for hexagonal workpieces

(76) Inventor: George William Kennel, Columbus, NJ (US)

Correspondence Address: Patrick H. Higgins, Mathews, Collins, Shepherd & McKay, Suite 306, 100 Thanet Circle, Princeton, NJ, 08540, US

(21) Appl. No.: 10/417,897

(22) Filed: Apr. 17, 2003

(51) Int. Cl. B25B 13/16

(52) U.S. Cl. 81/175

(57) ABSTRACT

An adjustable wrench is provided which possesses ratchet and locking features for turning a hexagonal workpiece indefinitely, by a series of clockwise and counterclockwise arcs, without disengaging the tool from the workpiece, comprised of an elongated body (2) having a first end (8) and a second end (9) and a longitudinal surface (4) for facing the workpiece, a fixed jaw (6) at a first end (8) of the body (2) having a substantially flat face (10) for contacting the workpiece wherein said fixed jaw (6) terminates with a driving lobe (12) for contacting the workpiece, a jaw movable (14) along an axis substantially parallel (16) to the longitudinal surface (4) of the body (2), said movable jaw (14) having a face (18) for contacting and pushing the workpiece against the face (10) of the fixed jaw (6) and the driving lobe (12); and a means for adjusting (20) a position of the movable jaw (14) along the axis substantially parallel (16) to the longitudinal surface (4) of the body (2).

### FIELD OF THE INVENTION

The present invention generally relates to an adjustable wrench having ratchet and locking features for turning a hexagonal workpiece. More particularly it relates to an adjustable wrench having a movable jaw for contacting and pushing the workpiece against the face of a fixed jaw and driving lobe. The shape and spatial position of the movable jaw relative to shape and dimension of the fixed jaw as well as the dimension of the driving lobe provides the locking and ratcheting mechanisms of the present invention which enables an operator to turn the workpiece indefinitely, by a series of clockwise and counterclockwise arcs, without disengaging the tool from the workpiece.

### BACKGROUND OF THE INVENTION

General examples of non-ratcheting adjustable wrenches are shown, for example, in U.S. Pat. No. 2,912,891, issued Nov. 17, 1959, to T. Neff, U.S. Pat. No. 3,204,497, issued Sep. 7, 1965, to L. R. Dinkler, U.S. Pat. No. 4,520,699, issued Jun. 4, 1985, to M. Jeremic, U.S. Pat. No. 4,967,613, issued Nov. 6, 1990 to R. E. Cone, and U.S. Pat. No. 5,415,064, issued May 16, 1995 to C-H. Chang. The standard arrangement for such adjustable wrenches is to have two jaws, one fixed with respect to the wrench handle and the other movable with respect to the fixed jaw. Typically, as is illustrated in the aforesaid patents, the movable jaw has an actuator element onto which an external male thread is formed, the movable jaw being attached to the actuator element by any one of a variety of means. The handle includes a knurled knob which has a complementary female threaded aperture extending therethrough, through which the male threaded actuator element extends so as to engage the female threads. Manual rotation of the knob, as by a user's thumb, causes the rotary motion of the knob to be translated into linear motion of the movable jaw, so as to selectively either clamp the jaws on to the element to which torque is to be applied or to loosen the jaws therefrom.

Non-adjustable ratcheting wrenches are well known in the prior art. They fall generally into two classes, box end wrenches with an external ratcheting mechanism for the box, such as is shown in U.S. Pat. No. 4,748,875, issued Jun. 7, 1988 to John W. Lang, for example, and open end wrenches utilizing unique gripping surfaces, such as is shown in U.S. Pat. No. 4,889,020, issued Dec. 26, 1989 to David R. Baker, for example. Stowjanowski, U.S. Pat. No. 4,825,731 ('731) discloses discloses an open-ended wrench having a conventional shaped and positioned but ratchetable jaw. Wylie, U.S. Pat. No. 4,848,193 ('193) discloses a conventional spring-loaded-jaw open-ended wrench. However such prior art non-adjustable ratcheting wrenches suffer from a common lessened degree of utility in that a given wrench may only be utilized with a single size of workpiece, necessitating the availability of a multiplicity of wrench sizes to insure availability of the ratcheting function.

Adjustable ratcheting wrenches are also known in the prior art. U.S. Pat. Nos. 3,803,954 and 5,095,782, for example, disclose adjustable ratchet wrenches which have a handle that pivots with respect to the jaws of the wrench. The pivoting action serves two purposes. One purpose is to tighten the wrench jaws on a nut or bolt. The other purpose is to turn the nut or bolt. In using this type of adjustable ratchet wrench, a relatively large portion of the motion of the handle in using the wrench is consumed by tightening the jaws of the wrench on the nut or bolt. Therefore, a reduced portion of the motion of the handle is utilized for the main function of the wrench which is turning the nut or bolt. In this respect, it would be desirable if an adjustable ratchet wrench device were provided in which substantially all of the motion of the handle of the device were utilized in turning the nut or bolt. Hillinger, U.S. Pat. No. 6,016,723 ('723), for example, discloses a closed-end wrench comprising a spring-loaded adjustable hexagonal aperture for receiving a hexagonal workpiece. Guimarin, U.S. Pat. No. 4,112,792 ('792), discloses an adjustable closed-end ratchet wrench including a disk member with ratchet teeth on its periphery and hub portions of reduced diameter on each side. A disadvantage of the adjustable ratchet wrench in this patent is that the end of the wrench is closed. In many instances, an open-ended wrench is needed for a variety of applications, and a closed ended wrench will simply not work. In this respect, it would be desirable if an adjustable ratchet wrench device were provided which included an open-ended wrench. Fossella, U.S. Pat. No. 5,090,273 discloses an adjustable ratchet wrench which includes three sliding jaws which are opened and closed by a cam disk. For purposes of simplicity, it would be desirable if an adjustable ratchet wrench were provided that has only one adjustable jaw. Mandigo, U.S. Pat. No. 5,377,566 ('566), discloses an open-ended adjustable wrench having a conventional shaped and positioned but ratchetable jaw. Stowjanowski, U.S. Pat. No. 5,890,404 ('404) discloses a conventional adjustable wrench having a ratchetable mechanism positioned below the conventional adjustable jaws. Galea, U.S. Pat. No. 5,095,782 ('782) discloses an open-ended adjustable wrench of a ratchet-type that automatically tightens the jaws closed onto a workpiece when the handle is rotated in one direction and which opens the jaws when the wrench is rotated in the opposite direction without removing the wrench from the nut or bolt.

Adjustable wrenches in the prior art tend to be cumbersome to turn a hexagonal workpiece sufficiently to meet the needs of the operator, inter alia, because the wrench needs to be continuously engaged and disengaged from the workpiece unless, of course, ample space is present around the workpiece for uninterrupted revolutions. However, even in circumstances wherein ample space may be present, the operator may desire a particular arc of position for turning the workpiece either for comfort, control, or precision that the task may require. A need therefore exists for a wrench having a ratchet feature, as well as a quickly adjustable locking feature, for turning a hexagonal workpiece. The need particularly exists for an adjustable wrench wherein the operator need not remove the wrench from the workpiece to turn the workpiece more than 360 degrees, for example, by means of a series of less than 360 degree arcs, with one hand.

### SUMMARY OF THE INVENTION

The present invention is directed to an adjustable wrench having ratchet and locking features for turning a hexagonal workpiece comprised of an elongated body (2) having a first end (8) and a second end (9) and a longitudinal surface (4) for facing the workpiece, a fixed jaw (6) at a first end of the body (8) having a substantially flat face (10) for contacting the workpiece wherein said fixed jaw (6) terminates with a driving lobe (12) for contacting the workpiece, a jaw movable (14) along an axis substantially parallel (16) to the longitudinal surface (4) of the body (2), said movable jaw (14) having a face (18) for contacting and pushing the workpiece against the face (10) of the fixed jaw (6) and the driving lobe (12); and a means for adjusting (20) a position of the movable jaw (14) along the axis substantially parallel (16) to the longitudinal surface (4) of the body (2).

In addition, the current invention is directed to embodiments in which the driving lobe (12) is cylindrical in structure, an axis of which (22) is about perpendicular to the axis substantially parallel (16) to the longitudinal surface (4) of the body (2), and wherein the axis (22) of the cylindrical driving lobe (12) is about coplanar with the face (10) of the fixed jaw (6).

### BRIEF DESCRIPTION OF THE FIGURES

FIG. 1 is a side elevation partially sectioned view of a basic embodiment of an adjustable wrench having ratchet and locking features for turning a hexagonal workpiece.

FIG. 2A is a front elevation view of the basic embodiment shown in FIG. 1. FIG. 2B is a bottom elevation view of the same embodiment.

FIG. 3A is a side view illustration of the locking feature of a basic embodiment of an adjustable wrench of the present invention wherein a fixed jaw (6) terminates with a driving lobe (12) and a movable jaw (14) contacts and pushes a workpiece against a face (10) of the fixed jaw (6) as well as the driving lobe (12). FIG. 3B is a side view illustration of the ratchet feature of a basic embodiment of an adjustable wrench of the present invention.

FIG. 4A is a side view illustration of an adjustable wrench of the present invention wherein the face (10) of the fixed jaw (6) creates an about 120 degree angle from the axis substantially parallel (16) to the longitudinal surface (4) of the body (2). FIG. 4B is a side view illustration of an adjustable wrench of the present invention wherein the face (18) of the movable jaw (14) creates an about 60 degree angle from the axis substantially parallel (16) to the longitudinal surface (4) of the body (2).

### DETAILED DESCRIPTION OF THE INVENTION

Unless defined otherwise, all technical and scientific terms used herein have the same meaning as is commonly understood by one of skill in the art to which this invention belongs. All publications and patents referred to herein are incorporated by reference.

“Hexagonal workpiece” as used herein generally refers to a conventional six sided nut or bolt head; however, as used herein, the term is intended to encompass other hexagon entities.

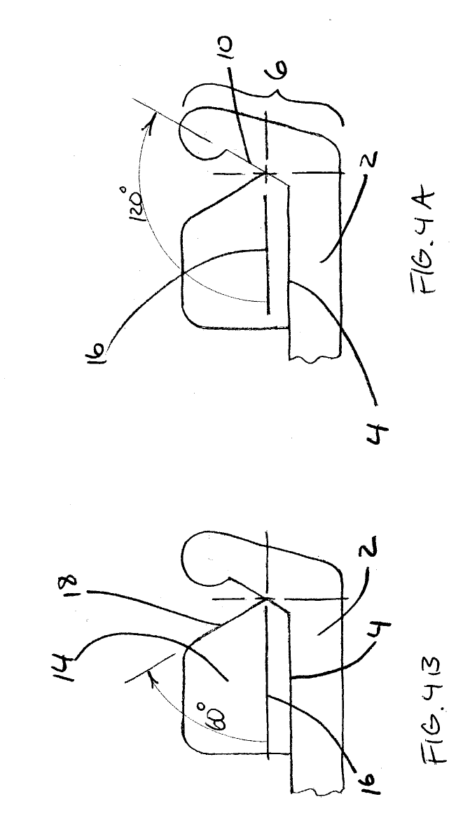

“Engaged with the workpiece” as used herein refers to contact of the adjustable wrench of the present invention with the hexagonal workpiece, for example as shown in FIG. 3A and 3B.

The current invention is particularly suited for quickly and conveniently turning hexagonal workpieces, e.g., conventional nuts and bolt heads. The adjustable wrench described herein has particular ratchet and locking features further described infra that allow the operator to turn the workpiece indefinitely, by a series of clockwise and counterclockwise arcs, without disengaging the tool from the workpiece. An indefinite series of arcs, each less than 360 degrees, for example, may be employed by an operator using the adjustable wrench having ratchet and locking features described herein to turn the workpiece with one hand indefinitely.

“Locking effect” or “feature” as used herein refers to the ability the wrench of the present invention, when turned clockwise, for example with reference to FIG. 3A, to turn the hexagonal workpiece while engaged with the workpiece. As a physical corollary, the same wrench may be flipped over and employed to likewise engage and turn the same workpiece counterclockwise.

“Ratchet effect” or “feature” as used herein refers to the ability the wrench of the present invention, when turned counterclockwise, for example with reference to FIG. 3B, not to (substantially) turn the hexagonal workpiece while engaged with the workpiece. As a physical corollary, the same wrench may be flipped over and employed to likewise ratchet clockwise.

The shape and spatial position of the movable jaw (14) relative to shape and dimension of the fixed jaw (6) as well as the dimension of the driving lobe (12) enables the ratcheting mechanism of the present invention. See FIG. 3A and FIG. 3B. With reference to FIG. 3A, when in operation for locking and turning the hexagonal workpiece, the fixed jaw (6) contacts two corners of the workpiece. One side of the hexagonal workpiece rests against the substantially flat face (10) of the fixed jaw (6) while a second adjacent side of the workpiece rests against the driving lobe (12). This locking feature for clockwise turning, with reference to FIG. 3A, of the adjustable wrench of the present invention occurs by means of the movable jaw (14) which is adjusted and secured into a position wherein the face of the movable jaw (18) contacts one side of the workpiece and pushes the workpiece against the face (10) of the fixed jaw (6) as well as the driving lobe (12) as described supra thereby locking the workpiece in the clockwise grip. Particularly with reference to FIG. 3A, the locking feature of the present invention is activated wherein a first corner of the workpiece rests in a notch (42) created at the junction of the face (10) of the fixed jaw (6) and the driving lobe (12). As is indicated in FIG. 3B the ratchet feature of the present invention is actuated by turning the wrench counterclockwise. Accordingly, when the adjustable wrench having ratchet and locking features for turning a hexagonal workpiece of the present invention is locked onto a workpiece, as shown in FIG. 3A, the ratchet feature is actuated simply by turning the wrench counterclockwise as indicated in FIG. 3B. With reference to these same figures, however, i.e., FIG. 3A and FIG. 3B, as is logical, the same workpiece can be turned counterclockwise by an operator of the wrench simply by flipping the wrench over (i.e., 180 degrees about the axis substantially parallel (16) to the longitudinal surface (4) of the body) and adjusting the movable jaw (14) so that the locking feature is actualized in a counterclockwise grip. As a physical corollary, the ratchet feature is then actuated simply by turning the wrench clockwise.

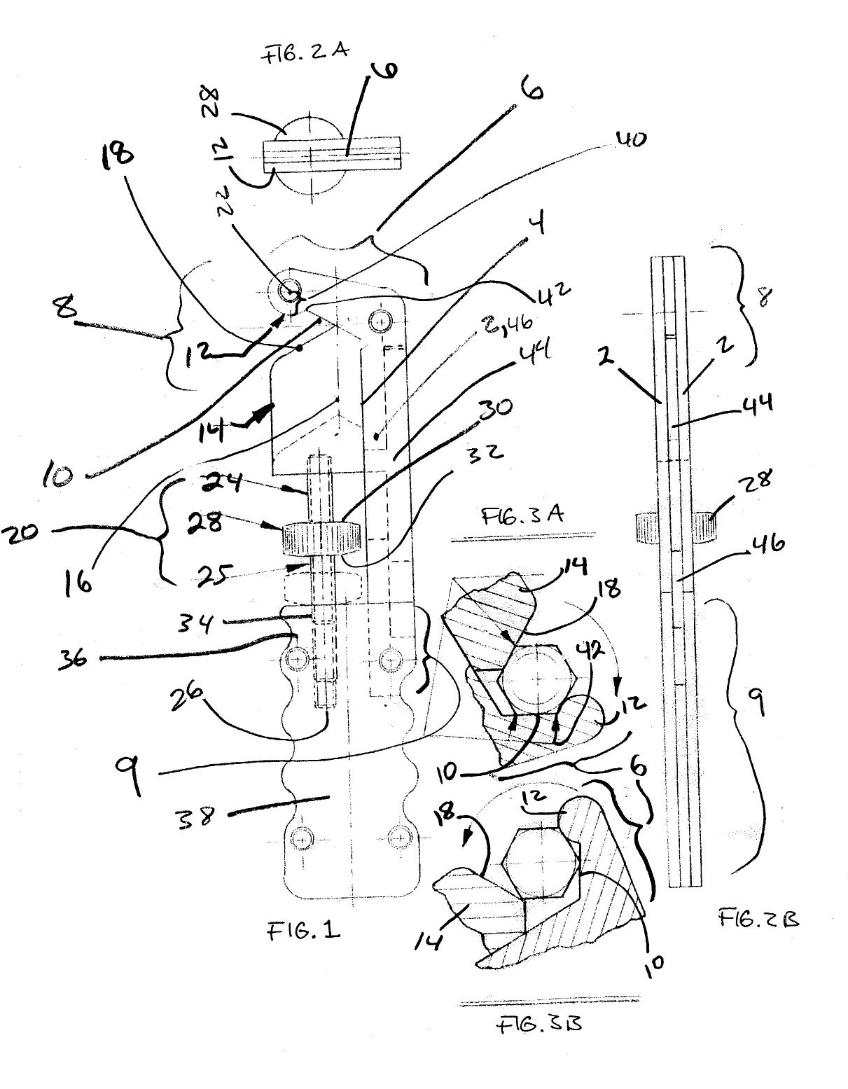

With reference to FIG. 1, an example of an adjustable wrench having ratchet and locking features for turning a hexagonal workpiece is shown which comprises an elongated body (2) having a first end (8) and a second end (9) and a longitudinal surface (4) for facing the workpiece, a fixed jaw (6) at a first end of the body (8) having a substantially flat face (10) for contacting the workpiece wherein said fixed jaw (6) terminates with a driving lobe (12) for contacting the workpiece, a jaw movable (14) along an axis substantially parallel (16) to the longitudinal surface (4) of the body, said movable jaw (14) having a face (18) for contacting and pushing the workpiece against the face (10) of the fixed jaw (6) and the driving lobe (12); and a means for adjusting (20) a position of the movable jaw (14) along the axis substantially parallel (16) to the longitudinal surface of the body (4).

An adjustable wrench of the present invention is preferred wherein the face (10) of the fixed jaw (6) creates an about 120 degree angle from the axis substantially parallel (16) to the longitudinal surface (4) of the body (2). FIG. 4A. A wrench of the present invention is also preferred wherein the face (18) of the movable jaw (14) creates an about 60 degree angle from the axis substantially parallel (16) to the longitudinal surface (4) of the body (2). FIG. 4B.

Embodiments of the present invention comprise a rounded bead (12) at the end of the fixed jaw (6) that is preferably cylindrical, spherical, or ellipsoid in structure. Preferably the driving lobe (12) is cylindrical in structure, an axis of which (22) is about perpendicular to the axis substantially parallel (16) to the longitudinal surface (4) of the body (2), and wherein the axis (22) of the cylindrical driving lobe (12) is about coplanar with (about on the same line as) the face (10) of the fixed jaw (6). See, FIG. 1.

A means for adjusting (20) a position of the movable jaw (14) along the axis substantially parallel (16) to the longitudinal surface (4) of the body (2) is contemplated, for example, wherein the movable jaw (14) is slidably engaged with the longitudinal surface (4) of the body and wherein a liftable retainer clip connected to the movable jaw (14), manipulated directly or indirectly by the operator's thumb, may be inserted into any of a plurality of lateral notches in the longitudinal surface (4) of the body (2) thereby adjusting and locking the movable jaw (14) to a preset position so that the wrench may conveniently be employed to turn a standard size workpiece.

An example embodiment of the adjustable wrench of the present invention is wherein a means for adjusting (20) the movable jaw (14) comprises a bolt (25) having a first end (24) and a second end (34) wherein the first end (24) is connected to the movable jaw (14). The bolt is preferably substantially parallel to the axis substantially parallel (16) to the longitudinal surface (4) of the body (2). Preferred embodiments are constructed wherein the bolt (24) is a threaded bolt rotatably connected to the movable jaw (14). In a preferred embodiment of the present invention as shown in FIG. 1 the threaded bolt (25) passes through an axis (26) of an adjusting wheel (28) and is fixed to said adjusting wheel wherein said adjusting wheel has a first side (30) and a second side (32) created by a plane perpendicular to the axis (26) of the adjusting wheel. The threaded bolt (25) preferably has a second end (34) receivable into a housing (36) comprising a receiving thread, which housing is connected to the body (2). An adjustable wrench of the present invention as shown in FIG. 1 is wherein the second end (9) of the elongated body (2) comprises a handle (38) for providing leverage for turning the wrench (applying torque to the workpiece). The handle (38) may be utilized as the housing (36) for receiving the second end (34) of the threaded bolt referred to supra. The movable jaw (14) may comprise a receivable thread and wherein the first end of the threaded bolt (24) is receivable into the movable jaw (14). Adjustable wrenches of the present invention may be constructed particularly for speed and convenience of adjustment wherein the bolt (25) is threaded in one orientation on the first side (30) of the adjusting wheel (28) and in an opposite orientation on the second side (32) of the adjusting wheel (28) so that upon rotation the bolt (24) retracts into the receiving thread of the movable jaw (14) and the bolt (34) retracts into the receiving thread of the housing (36), simultaneously; and that upon rotation in an opposite direction the bolt (24) extracts from the receiving thread of the movable jaw (14) and the bolt (34) extracts from the receiving thread of the housing (36), simultaneously. A RH (right handed) and LH (left handed) threaded bolt (25) on opposite sides of the adjusting wheel (24, 34) enables quicker movement (double speed) of the movable jaw (14) and minimizes axial play in the locking mechanism. Preferred embodiments of the present invention are quickly adjustable with one hand particularly due to the bolt (25) being RH and LH threaded on opposite sides (30, 32) of the adjusting wheel.

Adjustable wrenches of the present invention are preferred wherein the movable jaw (14) is slidably engaged by means of an extension member or guide (44) of the movable jaw (14) inserted into a longitudinal track (46) in the longitudinal surface (4) of the body (2). The guide (44) may be T-shaped for example, as shown in FIG. 1. This feature of embodiments of the invention provide integral stability and minimizes lateral movement of the movable jaw (14) with reference to the longitudinal surface (4) of the elongated body (2).

Embodiments of the present invention have a portion of the face (18) of the movable jaw (14) in proximity to the longitudinal surface (4) of the body (2) truncated, as shown in FIG. 1.

The adjustable wrench described herein is scalable to effectively engage and operate as described herein with all sizes (i.e., all widths, lengths, and thicknesses) of hexagonal workpieces. Preferred embodiments of the wrench, for example, are suitable for operation with conventional hexagonal workpieces which range in size from about ¼ inch diameter to about ¾ inch diameter as well as metric sized workpieces which range in size from about 6 mm in diameter to about 20 mm in diameter. Accordingly, preferred embodiments of the current invention range in total length of about 5 inches to about 10 inches. An embodiment shown in FIG. 1 for example is about 7½ inches in length. The face (10) of the fixed jaw (6) of an example embodiment described herein is about 11/16 inch (about 17.1 mm) in length. The face (18) of the moving jaw (14) of an example embodiment described herein is about ¾ inch (about 19 mm) in length. The driving lobe (12) is a bead on the first end (8) of the body (2) preferably a cylindrical structure, an axis of which (22) is about perpendicular to the axis substantially parallel (16) to the longitudinal surface (4) of the body (2), and wherein the axis (22) of the cylindrical driving lobe (12) is about coplanar with (about on the same line as) the face (10) of the fixed jaw (6). See, FIG. 1. The radius (40) of the cylindrical driving lobe (12), from the axis (22) of the driving lobe (12), is preferably between about 3/16 and about ¼ inch. The driving lobe (12) is preferably cylindrical for at least about 100 degrees with reference to the radius thereof (40). The driving lobe (12) is cylindrical for at least about 105 degrees with reference to the radius thereof (40), beginning at a point (42) about where the driving lobe (12) meets, or would otherwise meet (if not for a notch, for example), the face (10) of the fixed jaw (6), in a preferred embodiment of the present invention. See, e.g., FIG. 1.

These dimensions, however, are merely examples of a certain working embodiment and may be varied across a very wide scalable range to create a myriad of different actual embodiments of the invention.

The adjustable wrench having ratchet and locking features for turning a hexagonal workpiece of the present invention is a rigid piece of hardware. Accordingly, it may be manufactured from any type of material suitable for contacting and withstanding the material stress associated with turning nuts and bolt heads.

All publications and patents mentioned in the above specification are herein incorporated by reference. Various modifications and variations of the described compositions and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described compositions and modes for carrying out the invention which are obvious to those skilled in the art or related fields are intended to be within the scope of the following claims.

What is claimed is:

1. An adjustable wrench having ratchet and locking features for turning a hexagonal workpiece comprising:
an elongated body (2) having a first end (8) and a second end (9) and a longitudinal surface (4) for facing the workpiece,
a fixed jaw (6) at a first end of the body (8) having a substantially flat face (10) for contacting the workpiece wherein said fixed jaw (6) terminates with a driving lobe (12) for contacting the workpiece,
a jaw movable (14) along an axis substantially parallel (16) to the longitudinal surface (4) of the body, said movable jaw (14) having a face (18) for contacting and pushing the workpiece against the face of the fixed jaw (10) and the driving lobe (12); and
a means for adjusting (20) a position of the movable jaw (14) along the axis substantially parallel (16) to the longitudinal surface (4) of the body (2).

2. An adjustable wrench according to claim 1 wherein the face (10) of the fixed jaw (6) creates an about 120 degree angle from the axis substantially parallel (16) to the longitudinal surface (4) of the body.

3. An adjustable wrench according to claim 2 wherein the face (18) of the movable jaw (14) creates an about 60 degree angle from the axis substantially parallel (16) to the longitudinal surface (4) of the body.

4. An adjustable wrench according to claim 3 wherein the driving lobe (12) is a rounded bead structure.

5. An adjustable wrench according to claim 4 wherein the driving lobe (12) is cylindrical in structure, an axis of which (22) is about perpendicular to the axis substantially parallel (16) to the longitudinal surface (4) of the body, and wherein the axis of the cylindrical driving lobe (22) is about coplanar with the face of the fixed jaw (10).

6. An adjustable wrench according to claim 4 wherein the means for adjusting (20) the movable jaw (14) comprises a bolt (24) having a first end connected to the movable jaw.

7. An adjustable wrench according to claim 6 wherein the bolt (24) is substantially parallel to the axis substantially parallel (16) to the longitudinal surface (4) of the body.

8. An adjustable wrench according to claim 7 wherein the bolt (24) is a threaded bolt rotatably connected to the movable jaw (14).

9. An adjustable wrench according to claim 8 wherein the threaded bolt (24) passes through an axis (26) of an adjusting wheel (28) and is fixed to said adjusting wheel wherein said adjusting wheel has a first side (30) and a second side (32) created by a plane perpendicular to the axis (26) of the adjusting wheel.

10. An adjustable wrench according to claim 9 wherein the threaded bolt (24) has a second end (34) receivable into a housing (36) comprising a receiving thread, which housing is connected to the body (2).

11. An adjustable wrench according to claim 10 wherein the second end (9) of the elongated body (2) comprises a handle (38) for turning the wrench.

12. An adjustable wrench according to claim 11 wherein the handle (38) is the housing (36).

13. An adjustable wrench according to claim 10 wherein the movable jaw (14) comprises a receivable thread and the first end of the threaded bolt (24) is receivable into the movable jaw (14).

14. An adjustable wrench according to claim 13 wherein the bolt (24) is threaded in one orientation on the first side (30) of the adjusting wheel (28) and in an opposite orientation on the second side (32) of the adjusting wheel.

15. An adjustable wrench according to claim 5 wherein the radius (40) of the cylindrical portion of the driving lobe (12) from the axis (22) of the driving lobe (12) is between about ⅛ and about ¼ inch.

16. An adjustable wrench according to claim 15 wherein the driving lobe (12) is cylindrical for at least about 100 degrees with reference to the radius thereof (40).

17. An adjustable wrench according to claim 16 wherein the driving lobe (12) is cylindrical for at least about 105 degrees with reference to the radius thereof (40), beginning at a notch (42) about where the driving lobe (12) meets the face (10) of the fixed jaw (6).

18. An adjustable wrench according to claim 5 wherein the movable jaw (14) is slidably engaged by means of an extension member (44) of the movable jaw (14) inserted into a track (46) in the longitudinal surface (4) of the body (2).

19. An adjustable wrench according to claim 5 wherein a portion of the face (18) of the movable jaw (14) in proximity to the longitudinal surface (4) of the body is truncated.

20. An adjustable wrench having ratchet and locking features for turning a hexagonal workpiece comprising:
an elongated body (2) having a first end (8) and a second end (9) and a longitudinal surface (4) for facing the workpiece,
a fixed jaw (6) at a first end of the body (8) having a substantially flat face (10) for contacting the workpiece wherein said fixed jaw (6) terminates with a driving lobe (12) for contacting the workpiece, wherein the driving lobe (12) is cylindrical in structure, an axis of which (22) is about perpendicular to the axis substantially parallel (16) to the longitudinal surface (4) of the body, and wherein the axis of the cylindrical driving lobe (22) is about coplanar with the face (10) of the fixed jaw (6),
a jaw movable (14) along an axis substantially parallel (16) to the longitudinal surface (4) of the body (2), said movable jaw (14) having a face (18) for contacting and pushing the workpiece against the face (10) of the fixed jaw (6) and the driving lobe (12); and
a means for adjusting (20) a position of the movable jaw (14) along the axis substantially parallel (16) to the longitudinal surface (4) of the body (2).
